(19) United States
(12) Patent Application Publication
(10) Pub. No.: US 2024/0311087 A1
(43) Pub. Date: Sep. 19, 2024

(54) Deeply Integrated Development Environment

(71) Applicant: Satya Bathula, Taylorsville, UT (US)

(72) Inventor: Satya Bathula, Taylorsville, UT (US)

(21) Appl. No.: 18/606,716

(22) Filed: Mar. 15, 2024

Related U.S. Application Data
(60) Provisional application No. 63/490,514, filed on Mar. 15, 2023.

(51) Int. Cl. G06F 8/20; G06F 8/35

(52) U.S. Cl. CPC G06F 8/20; G06F 8/35

(57) ABSTRACT

Technology is described for enabling development of a computer application using a cloud-based application development service. The method can include generating, using a design codebase generating service, a design codebase for the computer application, the design codebase defining a front-end and a back-end in a base programming language; selecting one or more target programming languages, the one or more target programming languages different than the base programming language; and generating, using a source code generating service, a first set of source code for the computer application in the one or more target programming languages from the design codebase.

This patent application claims the benefit of priority to U.S. Provisional Patent Application No. 63/490,514, filed on Mar. 15, 2023, entitled “Deeply Integrated Development Environment”, the entire contents of which are hereby incorporated by reference.

### BACKGROUND

Many mobile and web applications may include a front end (client side) and a back end (server side). The front end of an application may refer to the part of the application that users interact with directly through a mobile client, desktop client or in their web browsers, the front end may encompass the user interface (UI) and user experience components of the application. Front-end development involves creating and designing these components to ensure that the application is visually appealing, responsive, and intuitive for users to navigate.

The back end of an application refers to the server-side components and functionality that are responsible for processing requests, managing data, and executing the logic behind the scenes. The back end typically runs on a server (e.g., a web server, database server, etc.). Unlike the front end, which deals with what users see and interact with in their web browsers, the back end operates on the server-side and is not directly visible to users. The back end also typically involves interacting with a data store or database to store, retrieve, and manipulate data. The back end may also include application program interfaces (APIs) that allow communication and interaction with the front end and the database. APIs may define the endpoints, request/response formats, and authentication mechanisms for accessing and manipulating data or performing specific actions.

Developers may create applications using an Integrated Development Environment (IDE). An IDE is a software application that provides comprehensive facilities to developers for software development. An IDE typically includes a source code editor, build automation tools, and a debugger, among other features, all integrated into a single user interface. Some IDEs allow developers to create graphical user interfaces (GUIs) by visually designing the layout of the front end of their applications using pre-built components or widgets that can be dragged and dropped onto a canvas or form.

Even using current IDEs, a developer must still program most of the front end and the back end of an application separately, while using different programming languages spread across multiple files. That is, developers must laboriously code applications mostly from scratch. In fact, in many instances, development of an application requires front-end developers and back-end developers. Front-end developers may use client-side programming languages such as Hypertext Markup Language (HTML), Cascading Style Sheets (CSS), and JavaScript. Back-end developers use server-side programming languages to implement the business logic and functionality of the application. Common back-end languages include JavaScript (Node.js), Python (Django, Flask), Ruby (Ruby on Rails), Java (Spring Boot), PHP (Laravel), Express.js (JS), PHP and C#(ASP.NET). The back-end of applications may also connect to a relational database management system for building and managing databases. Examples of RDBMSs include MYSQL, MariaDB, and PostgresSQL.

FIG. 1 depicts an example of an application architecture 10 having a front end 12 and a back end 14. The front end 12 can be the presentation layer of an application and presents all the data that an end user sees on a user device 14. More generally, the front end 12 is any code that is responsible for efficiently displaying data to the user. The back end may include a server, such as a web server 16. The web server 16 can run the application logic 18. The web server 16 may be connected to a relational database management system for managing data in a database 20. Other types of data stores or databases may also be used. The back end 14 may also include a file system 22 for managing application files, including files for generating the front end 12. The front end 12, as displayed on user device 14, and the back end 14 are connected by a network 24.

Based on the foregoing, several drawbacks exist to traditional IDEs and environments used by developers to create mobile, desktop and/or web applications. It would therefore be an improvement in the art to provide an application development environment that revolutionizes the way developers design, develop, and deploy applications.

### BRIEF DESCRIPTION OF THE DRAWINGS

FIG. 1 is a block diagram illustrating an example of a software application architecture for a front-end and back-end model.

FIG. 2A is a block diagram illustrating an example of an architecture for a cloud-based application development environment according to some embodiments.

FIG. 2B is a block diagram illustrating an example of core models for use in a cloud-based application development environment according to some embodiments.

FIG. 2C is a block diagram illustrating an example of creating source code from core models and a design codebase according to some embodiments.

FIGS. 3-9 are diagrams illustrating examples of data models according to some embodiments.

FIGS. 10-13 are diagrams illustrating examples of inputs for query models according to some embodiments.

FIG. 14 is a diagram illustrating an example of option sets according to some embodiments.

FIG. 15 is a diagram illustrating an example of a structure according to some embodiments.

FIG. 16 is a diagram illustrating an example of a class according to some embodiments.

FIG. 17 is a block diagram illustrating an example of a developer interface according to some embodiments.

FIG. 18 is a block diagram illustrating an example of a developer interface according to some embodiments.

FIG. 19 is a block diagram illustrating an example of a developer interface according to some embodiments.

FIG. 20 is a block diagram illustrating an example of a developer interface according to some embodiments.

FIG. 21 is an example of a flowchart illustrating a method for enabling development of a software application according to some embodiments.

FIG. 22 is an example of a flowchart illustrating a method for enabling development of a software application according to some embodiments.

FIG. 23 is a block diagram that provides an example illustration of a server computing device that may be employed in the present technology according to some embodiments.

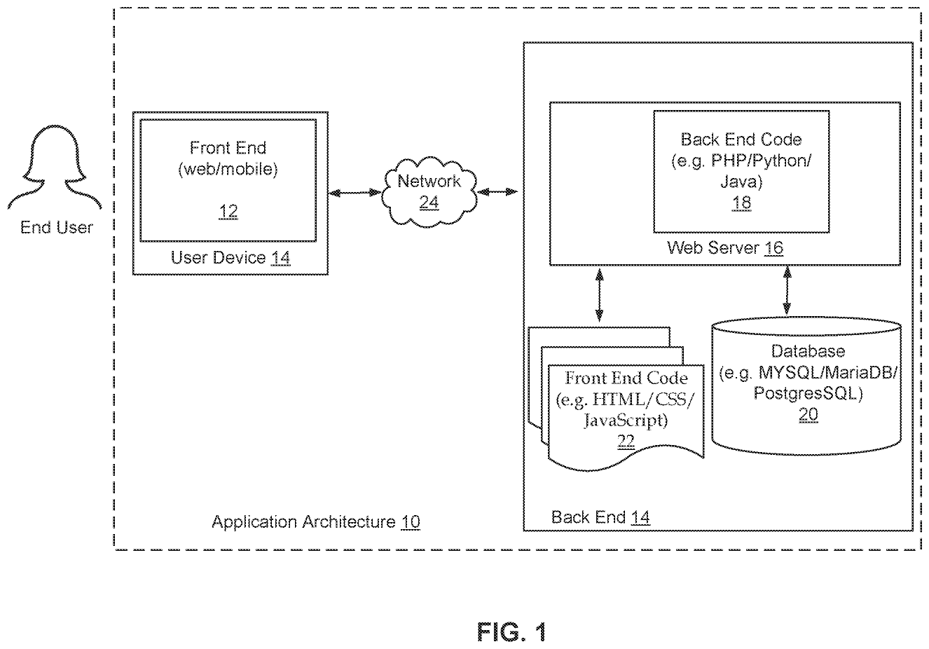

### DETAILED DESCRIPTION

Technologies are described herein for a server-based application development environment (ADE) (e.g., cloud based) that facilitates the design, development, and deployment of software applications. In one example, the ADE automatically creates applications based on user-defined high-level structures. That is, the ADE automatically generates most, if not all, of the source code needed for the applications. In an example, the ADE may generate the source code in the users' preferred programming languages. Once the source code has been generated, the ADE may automatically deploy the application to a web or application server.

In an example, the ADE is hosted on a server infrastructure and is accessible to users through mobile clients, desktop clients or web browsers. The ADE may allow users to create software applications entirely online without needing to install any software locally on their machines. Since the ADE runs on cloud or server infrastructure, it can easily scale resources based on demand, ensuring optimal performance even when handling large projects or heavy workloads. Users can access the ADE from any device with an internet connection, making it highly accessible and flexible.

In an example, the cloud or server infrastructure may include hardware and software components that are necessary to support the computing requirements of the ADE. The cloud infrastructure may encompass the entire ecosystem of servers, storage, networking, and management tools that enable the delivery of services over the web for the ADE. In an example, the infrastructure hosting the ADE may include server(s).

In an example, the ADE may provide a suite of services that allow users to develop applications having a front end and a back end, such a mobile and web applications. The server may provide services that allow users to develop applications that automatically communicate with databases, data models, and application program interfaces (APIs).

In an example, the ADE may provide user-friendly developer interfaces accessible to users via standard web browsers. The server may allow users to create software applications using user defined-high level structures. The server may allow users to create or join a team of users. Team owners may invite new team members to join by email invitations. Team members have access to all the projects created within the team. Each team member can contribute to project development, fostering collaboration and teamwork.

In an example, the ADE may allow users to define specific projects for each team. A project may include the development of a software application. The server may allow users to name, save and access projects through a web interface. The server may provide a project page that provides essential information about the project. This information may detail the components of the project, including project name, branch, pull requests, and build and deploy information.

In an example, the ADE may allow users to define models for a project. These models are components that define the structure and characteristics of data within an application. Models represent objects containing application data and shape both the backend functionality and the end-user interface. That is, models act as a blueprint for creating, storing, and interacting with information. Models may be used to generate database tables, their constraints, and their validation rules.

In an example, the ADE may allow users to predefine data queries that are used to request and manipulate data results from a database for a software application. A data query serves as a means to retrieve specific information based on predefined criteria.

In an example, the ADE may allow users to define option sets for a software application. Option sets provide users a way to define a set of predefined values (options). Option Sets are often used to represent enumerated values or a fixed set of choices.

In an example, the ADE may allow users to define classes for a software application. Classes are a fundamental programming construct that encapsulates data and methods within a logical unit. Classes serve as blueprints for creating objects, which are instances of those classes. Classes can be used to encapsulate and manage complex or lengthy logic, promoting code organization and reusability.

In an example, the ADE may allow users to define user types for a software application. User types involve various types of end users, each with specific roles, needs, and expectations.

In an example, the ADE may allow users to define data structures for a software application. Data structures serve as a way for users to define a structure for holding data.

In an example, the ADE may allow users to define scheduled actions for a software application. Scheduled actions allow users to automate tasks or events based on specified schedules. These actions can be triggered at predefined times or intervals, enhancing the flexibility and efficiency of data-driven processes.

In an example, the ADE may allow users to define UIs for software applications. In an example, the server may provide widgets to allow users to define the UIs for software applications. Widgets are the fundamental unit of the UI that represents a specific visual or functional element within an application. Widgets serve as building blocks for constructing the overall UI, and they can range from simple elements like buttons and text fields to more complex components such as charts, tables, and interactive controls.

In an example, the ADE may provide a canvas to allow users to define the UIs for software applications. The canvas may provide a central space for building the UI of applications that provides a visual interface where users can arrange, design, and organize various UI elements to create a cohesive and visually appealing experience for end users.

In an example, the ADE may allow a user to create core models for a project. The core models may include data models, data queries, option sets, classes, structures, scheduled actions, user types, widgets, and pages.

The ADE may provide a code generating service to generate code blocks or a design codebase for a project based on core models created by a user. In an example, the ADE may provide an artificial intelligence (AI) code generating service to generate code for the project in response to a user query. In a further example, the ADE may provide a code correction service to correct the code generated by the AI code generating service. In an example, the ADE may provide a code management service to integrate the corrected code and the design codebase generated by the code generating service.

In an example, a ADE may receive, through a developer user interface, a first user input that defines a data model for a project. The server may generate, using a code generation service, a design codebase for a project, the design codebase having data constraints based on the core models. The ADE may then receive, through the developer UI, a second user input that defines a request to an AI code generating service to generate code for the project as defined by the user query. The AI code generating service may be a generative AI such as a deep neural network that has been trained on the core models and source code model being used. The ADE may then generate, using the AI code generating service, a first set of computer code based on the second user input, wherein the first set of computer code is incompatible with the design codebase or has errors (e.g., AI hallucinations). The ADE may then generate, using a code correction service, a second set of computer code from the first set of computer code, wherein the second set of computer code is compatible with the design codebase. The ADE may then incorporate, using a code management service, the second set of computer code into the design codebase.

Reference will now be made to the examples illustrated in the drawings, and specific language will be used herein to describe the same. It will nevertheless be understood that no limitation of the scope of the technology is thereby intended. Alterations and further modifications of the features illustrated herein, and additional applications of the examples as illustrated herein, which would occur to one skilled in the relevant art and having possession of this disclosure, are to be considered within the scope of the description.

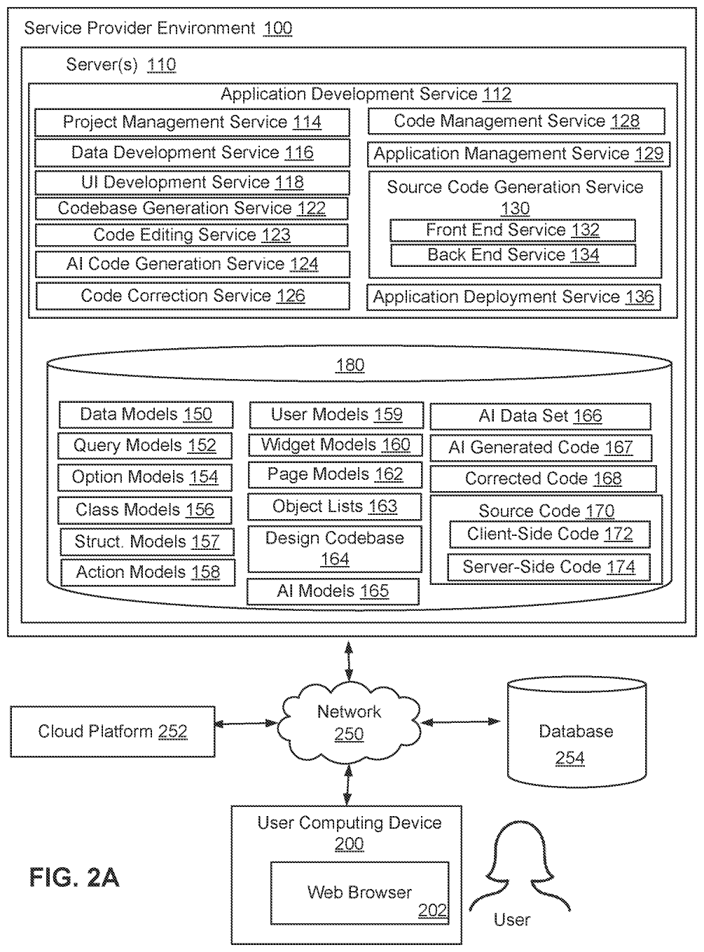

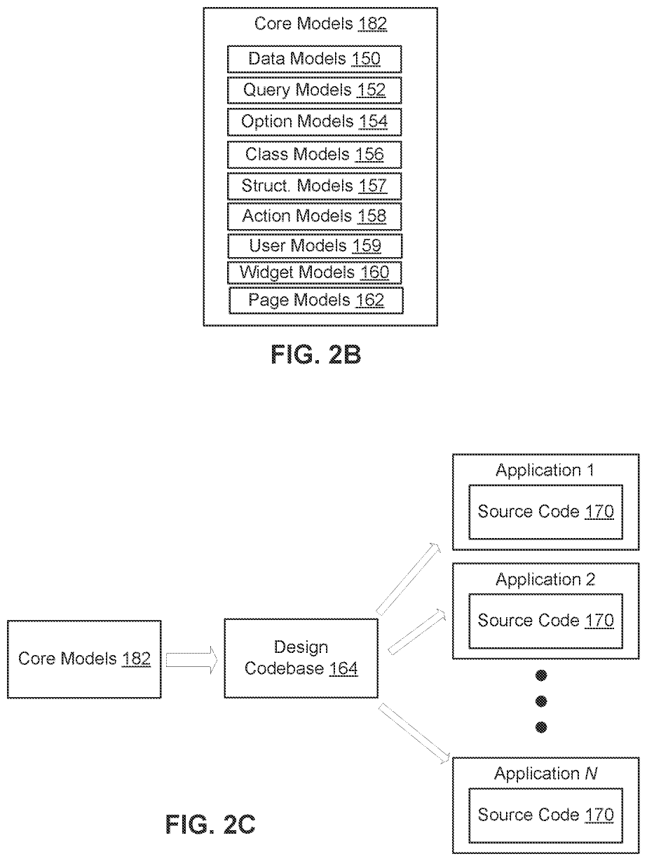

FIG. 2A illustrates an example of a service provider environment 100 for creating a software application. The environment 100 may include a computer server(s) 110 and data store 180 that provide a variety of services and allow a user to create a software application from a remote user computing device 200. The server 110 and the device 200 may be connected over a network 250.

The server 110 may comprise, for example, a processor-based system. The server 110 may include one or more processors and one or more memory devices. The data store 180 may comprise data storage devices, such as hard drives. The data store 180 may be local to the server 110. Alternatively, the data store 180 may be an online code repository, such as Git.

The user computing device 200 may comprise, for example, a processor-based system. The device 200 may be devices such as, but not limited to, desktop computers, laptops or notebook computers, tablet computers, mobile devices, mainframe computer systems, handheld computers, workstations, network computers, or other devices with like capability. Processor(s) of the device 200 may run a web browser 202 that is able to access services provided by the server 110.

The network 250 may include any useful computing network, including an intranet, the Internet, a localized network, a wide area network, a wireless data network, or any other such network or combination thereof. Components utilized for such a system may depend at least in part upon the type of network and/or environment selected. Communication over the network may be enabled by wired or wireless connections and combinations thereof.

FIG. 2A further illustrates that certain processing modules may be discussed in connection with this technology and these processing modules may be implemented as computing “services.” In one example configuration, a module may be considered a service with one or more processes executing on a server or other computer hardware. Such services may be centrally hosted functionality or a service application that may receive requests and provide output to other services or user devices. For example, modules providing services may be considered on-demand computing that are hosted by a server, virtualized service environment, grid or cluster computing system. An application programming interface (API) may be provided for each module to enable a second module to send requests to and receive output from the first module. Such APIs may also allow third parties to interface with the module and make requests and receive output from the modules. While FIG. 2A illustrates an example of a system that may implement the techniques above, many other similar or different environments are possible. The example environments discussed and illustrated above are merely representative and not limiting.

FIG. 2A further illustrates that the ADE may be provided as a software as a service (SaaS). SaaS is a cloud computing model in which software applications are hosted by a third-party provider and made available to customers over the Internet. In this model, customers access the software through a web browser or an API without needing to install, maintain, or manage the underlying infrastructure or software application. Alternatively, the ADE may be provided on a local computing device.

### Application Development Service

In an embodiment, the server 110 may provide a cloud-based application development service (ADS) 112 over the network 250 to one or more user device(s) 200. For example, the user device 200 may access the ADS 112 through the web browser 202. The ADS 112 may provide an all-in-one online application development environment that allows users to design, develop, and deploy multiple software applications from a single project, such as web-based and mobile applications. The ADS 112 empowers users to create software applications, including mobile applications, web applications, and their frontends and backends with improved efficiency as compared to previous techniques. The ADS 112 may reduce the amount of code a user needs to write for a software application. Instead, the ADS 112 allows users to define application requirements in high-level structures, known as core models, which are then used to generate a design codebase. From the design codebase, the ADS 112 can generate the source code for an application in one or more programming languages based on user preferences. That is, the ADS 112 allows a user to select the target source code type (e.g., Java, C#, etc.) for the application. Once the source code in the target source code type has been generated from the design codebase, the ADS 112 may deploy the application to a cloud platform, such as a web server. In addition, the ADS 112 may automatically create a database for the application in an online database hosting service selected by a user. The ADS 112 may comprise the various services, i.e. modules, as shown in FIG. 2A and described below.

### Project Management Service

In an embodiment, the server 110 may provide a cloud-based project management service 114 over the network 250 to the user device 200. For example, the user device 200 may access the service 114 through the web browser 202. The project management service 114 allows a user of the device 200 to create a team as its owner or join another team of users. Team owners can invite new members to join the team by sending invitations via email. Invitations contain a link for recipients to accept, making the onboarding process seamless. The service 114 may allow users to create projects. Team members have access to all the projects created within the team. Each member can contribute to project development, fostering collaboration and teamwork. Teams can have members with different roles, each with specific permissions. Roles may include Owners, Administrators, DevOps, Developer, Designer each with varying levels of access.

The project management service 114 may further allow users to create a project and assign the project to a team. Users may name each project and provide a brief description of the project. Once created, the project may be saved. The project management service 114 may provide a dashboard providing crucial information about the project's current state, collaboration activities, version control status, and deployment processes. Users can efficiently navigate, collaborate, and monitor the project's development and deployment lifecycle from this centralized hub. As will be explained in more detail below, one or more deployable applications may be generated from each project.

### Data Development Service

In an embodiment, the server 110 may provide a cloud-based data development service 116 over the network 250 to the user device 200. For example, the user device 200 may access the service 116 through a developer interface displayed in the web browser 202. The service 116 allows a user of the device 200 to define the structure, characteristics and relationships of data for a project. The service 116 may allow users to separately define core models for a project, including one or more of data models, data queries, option sets, classes, user types, data structures, scheduled actions, widgets and pages. Each of these is discussed below.

### Data Models

The data development service 116 may provide a cloud-based interface on the device 200 that allows a user to define one or more data models for a project. The data models represent data objects for holding application data. In this regard, the models play a role in shaping both the frontend and backend functionality of an application. For example, the back-end application may be generated based on the models defined by users for a project. The models may determine how data is stored in a database and associated with an application. The models may be associated with forms in the application, defining the data input and output for various UI components. Some models might not be visible in the UI of an application but are crucial for storing essential data.

The models may define data constraints for data. As used herein, the term “data constraints” refers to rules or conditions that data must adhere to in order to maintain its integrity, consistency, and usability within a computer application and/or database. Data constraints are applied to ensure that the data meets certain quality standards and remains valid and reliable for its intended purpose. As explained below, data constraints may comprise one or more of a “type” constraint, “required” constraint, “size” constraint, “length” constraint, “reference” constraint, “exists-if” constraint, “computed” constraint, “transient” constraint, “child” constraint, “unique” constraint, or a “validation” constraint.

The data development service 116 may allow a user to create and uniquely identify a model by a name. The data development service 116 may allow a user to give a detailed and informative explanation or representation of a model to help understand, identify, or explain the model. The data development service 116 may further allow a user to define properties of the data object represented by the model. These properties may include the attributes or fields of the data object represented by the model and the various characteristics and data types associated with the properties.

In an example, each property may encapsulate a specific piece of data within the object, providing a structured way to organize and describe the information in a project. The name of the property may serve as its identity within the model to uniquely identify a specific data field.

The data development service 116 may allow a user to designate a “type” of a property. The “type” data constraint of a property specifies the kind of data it can hold, which can be a primitive data type, another model, or an option set (explained below). The type defines the nature of the data the property can store, ensuring consistency and enabling the server 110 to generate appropriate tables in a database when its application is deployed.

The data development service 116 may further allow a user to designate a property of a model as a “required” data constraint. The “required” property in models specifies a data constraint, i.e., whether a particular property must have a value assigned. If a property is marked as “required”, it means that when creating or updating an object based on this model, a value for this property must be provided, and leaving it empty would result in an error. Designating a property as “required” ensures that crucial data is captured, enhancing the reliability and completeness of the information stored in the object.

The data development service 116 may further allow a user to indicate a “size” data constraint, i.e., that a property holds a single value or multiple values that essentially turn it into a list or an array. This is useful when a property needs to represent a collection of items rather than a single value. Identifying a property as a collection allows it to store multiple instances of the specified type, accommodating scenarios where multiple items are associated with a single entity. The data development service 116 may further allow a user to indicate default value(s) for a property of a model. This default value serves as a fallback, ensuring that the property always has a valid initial value even if not explicitly set.

The data development service 116 may further allow a user to indicate a “length” data constraint, i.e., a length of a data field of the property. For example, the length may indicate the number of characters a data field can hold.

The data development service 116 may further allow a user to define a property with a “reference” data constraint, i.e., the property references other properties within the same model. This is useful when a user wants to establish relationships or associations between different properties within the same model. Reference properties may be independent entities. They can exist on their own and typically represent a connection to another entity without directly embedding the referenced data. Reference properties are useful when a user wants to establish relationships between different models without duplicating the data.

The data development service 116 may further allow a user to define a property of a model under an “exists-if” data constraint. The “exists-if” attribute in model properties provides a conditional mechanism that determines whether a property should hold a value based on a specified condition. If the condition evaluates to true, the property holds the specified value; otherwise, it defaults to a predefined default value. It will be appreciated that this attribute is useful for making a property's value conditional on certain criteria, providing flexibility in determining when a property should be populated. The service 116 may further allow a user to define access control that specifically govern permissions for reading or writing objects within a model. Access control may include the following types: read and write, write once, read only, and local.

The data development service 116 may further allow a user to define a “computed” data constraint for properties. The term “computed” refers to computed properties or computed fields within a model. Computed properties allow you to define dynamic values that are calculated based on the values of other properties within the same model. These computed properties are not stored directly in the database but are calculated on-the-fly when requested. Computed properties are useful for deriving values dynamically, performing calculations, or aggregating data without directly storing the computed result in the database.

The data development service 116 may further allow a user to define a “transient” data constraint for properties. The term “transient” is used in the context of defining properties in models. A “transient” property is a property that is not persisted or stored in the database. It exists temporarily during the execution of certain actions or processes but is not permanently saved to a database. Transient properties are useful for representing temporary or calculated values that do not need to be stored permanently but are needed for a specific operation or calculation.

The data development service 116 may further allow a user to define “child” data constraint for properties. A “child” property is a property that is conceptually a part of another entity, often referred to as the parent entity. Child properties are dependent on the existence of the parent entity. Child properties do not exist independently. They are part of the parent entity and are typically saved or deleted along with the parent. Child properties are useful when there exists a hierarchical or composition relationship, and the child properties are closely tied to the existence of the parent entity.

The data development service 116 may further allow a user to define a “unique” data constraint for properties. The “unique” property in a model is used to define data constraints on a specific property. When a property is marked as unique, it means that each value in that property must be unique across all instances of the model. In other words, no two instances of the model should have the same value for the specified unique property.

The data development service 116 may further allow a user to define “validation” data constraints for properties. Property “validations” are used to enforce data constraints on the values that can be assigned to a specific property. Validations help ensure that the data adheres to predefined criteria, promoting data integrity and consistency. Property validations may include Error Messages, Expressions, Validate On Create/Validate On Update, and Server only. “Error Message” allows a user to specify a custom error message that will be displayed when the validation rule is not satisfied. A user can define a clear and descriptive error message to help users understand why the validation failed. “Expressions” allows a user to define a custom expression or condition that will be evaluated to determine if the validation rule is satisfied. “Validate On Create/Validate On Update” control when the validation should be triggered. “Validate On Create” specifies whether the validation should occur when creating a new instance, and “Validate On Update” specifies whether the validation should occur when updating an existing instance. “Server Only” indicates whether the validation should be performed only on the server side.

The data development service 116 may further allow a user to define “actions” that define the operations or behaviors associated with the model. That is, users may define how the data interacts with an application, including create, update, delete, user selection, schedule, create and update. Each action is given a name that is a unique identifier for the action. It provides a meaningful and recognizable name for the action, making it easier for users to reference and understand the purpose of the action. Each action may be assigned a “run on” component by a user that specifies the context or trigger on which the action should be executed. It defines when the action should run, such as: On create, On Update, On Delete, On User Selection, On Scheduled, and On Create and Update. Each action may have a “code” component defined by a user that specifies the logic and implementation details of the action. It defines the actual behavior that the action performs when triggered.

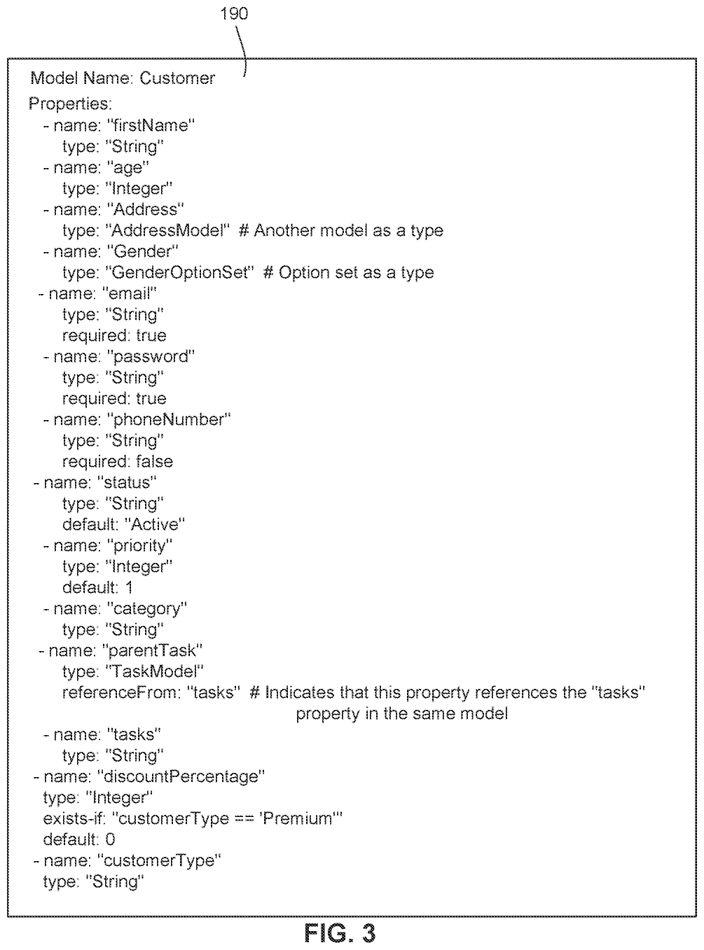

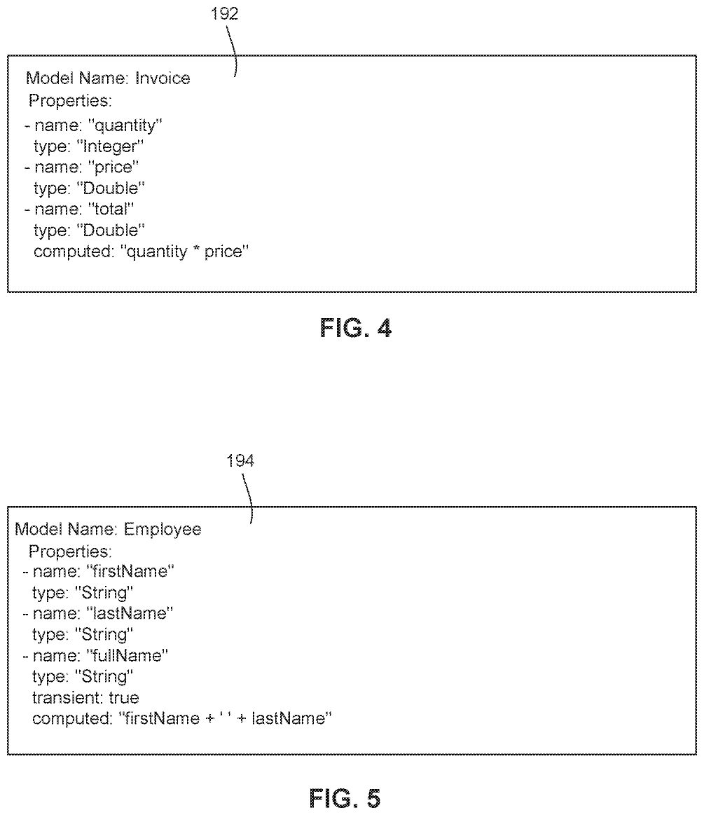

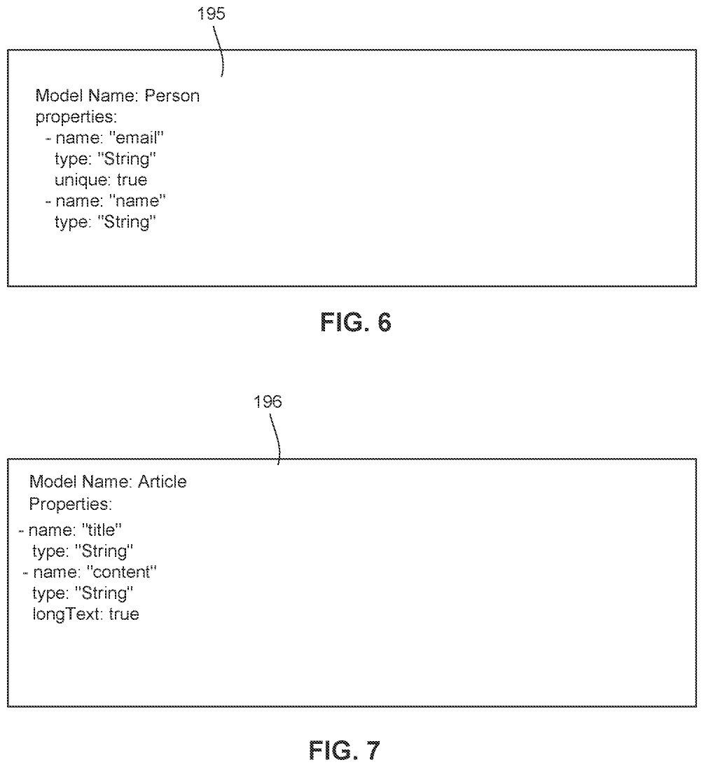

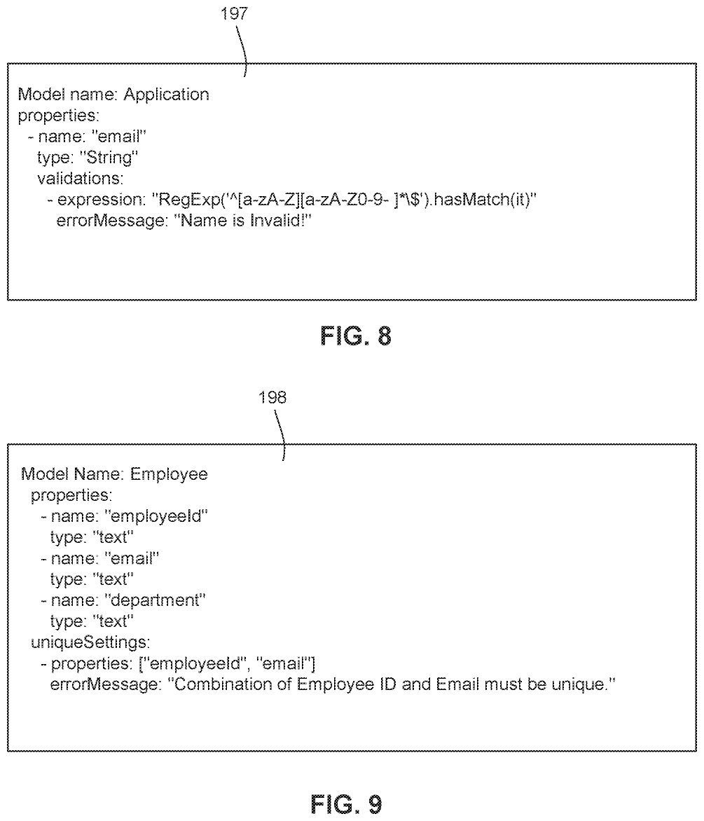

Once a user has defined the data models for a project, they are saved as data models 150 in the data store 180. Examples of data models 150 are shown in FIGS. 3-9 with various named properties and their associated data constraints. In FIG. 3, a “customer” data model 190 is shown. In FIG. 4, an “invoice” data model 192 is shown. In FIG. 5, an “employee” data model 194 is shown. In FIG. 6, a “person” data model 195 is shown. In FIG. 7, an “article” data model 196 is shown. In FIG. 8, an “application” data model 197 is shown. In FIG. 9, another “employee” data model 198 is shown.

### Data Queries

Referring back to FIG. 2A, the data development service 116 may allow a user to define data queries for a project. A data query is a tool used to request and manipulate data results from a database and serves as a means to retrieve specific information based on predefined search criteria. The data development service 116 may allow a user to provide a unique name for a data query that is used to reference the query. The data development service 116 may allow a user to specify the parameters (variables) that the query can accept. Inputs act as parameters that can be passed to a query, enabling dynamic and tailored data fetching. Inputs provide flexibility, allowing dynamic customization of query results. For example, in a query to get articles by title, the title is an input parameter that determines which articles are retrieved.

The components of inputs may include “name,” “type,” “collection,” “required,” and “validation.” The “name” property that provides a unique identifier for the input parameter within the data query. It is used to reference and access the input parameter in the query's code. The “type” property specifies the data type of the input parameter and helps define the expected format of the input value (e.g., String, Integer, Double, etc). The “collection” property indicates whether the input represents a single value or a collection (list or array) of values. It allows flexibility in handling single values or multiple values for the input. The “required” property determines whether the input is mandatory or optional. If set to true, the query expects the input to be provided; otherwise, it may be omitted. The “validation” property allows a user to define validation rules for the input. The service 116 may allow a user to use a code editor to define the logical and implementation details of the data queries.

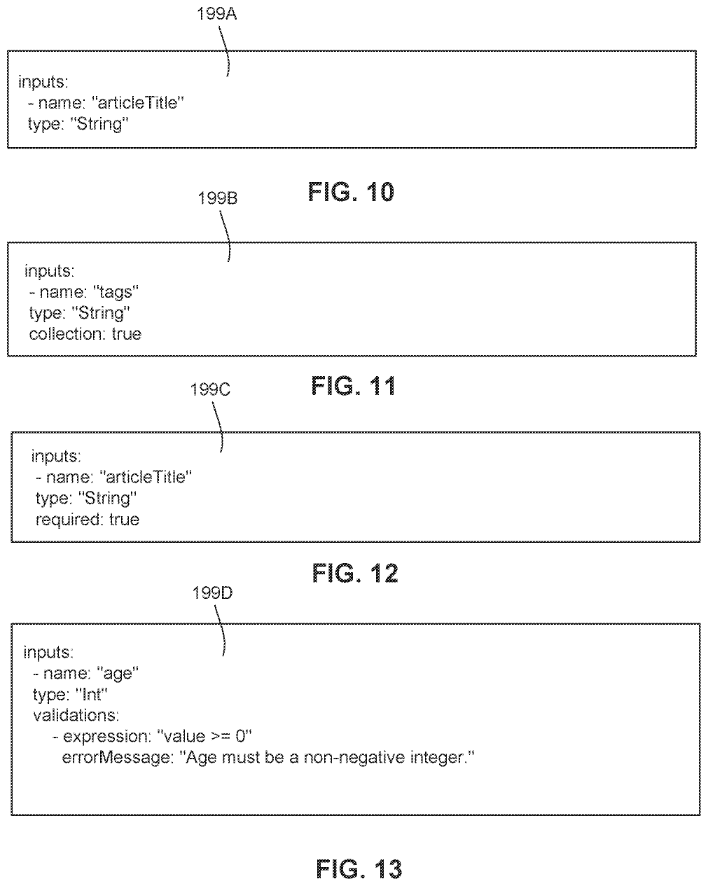

Once a user has defined the data queries for a project, they are saved as query models 152 in the data store 180. FIGS. 10-13 depict examples of inputs 199A-199D, respectively, used in query models 152.

### Option Sets

Referring back to FIG. 2A, the data development service 116 may allow a user to define option sets for a project. An option set is a way to define a set of predefined values (options) for a project. Option sets are often used to represent enumerated values or a fixed set of choices. It provides a predefined list of values. Each option in an option set can have associated attributes that provide additional features or information about that specific option. This allows for a more nuanced representation of the data and enhances the flexibility of using option sets. The data development service 116 may allow a user to define a unique name for each option set and the individual values or items within an option set. The service 116 may further allow a user to define the type of data an option set can hold as well as whether the option set contains a single value or a list.

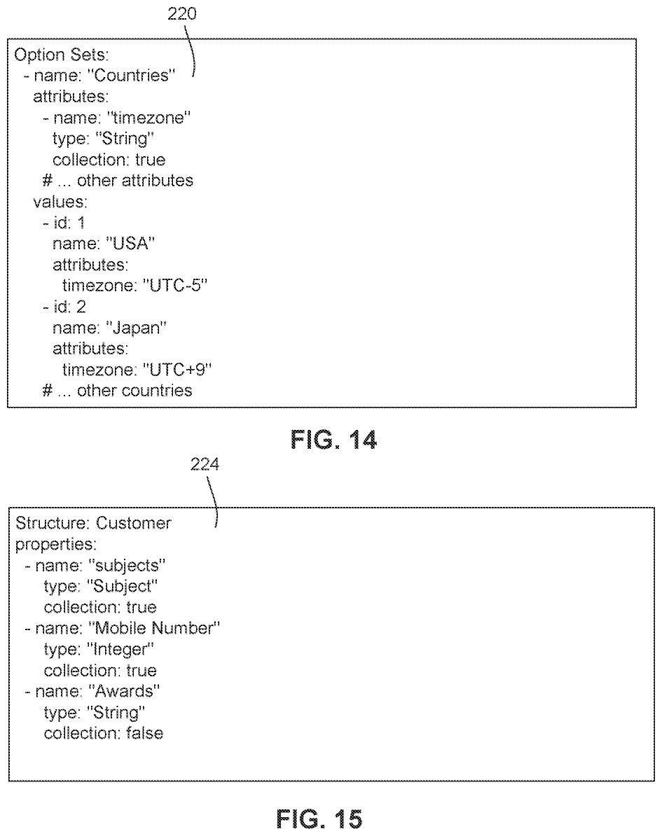

Once a user has defined the option sets for a project, they are saved as option models 154 in the data store 180. FIG. 14 shows an exemplary option set 220.

### Classes

Referring back to FIG. 2A, the data development service 116 may allow a user to define classes for a project. Classes are the fundamental programming construct that encapsulates data and methods within a logical unit. Classes serve as blueprints for creating objects, which are instances of those classes. Classes promote code organization and reusability within an application. The data development service 116 may allow a user to define variables and methods for each class.

Within each class, variables or attributes, define the data associated with objects of that class. Variables store the state or characteristics of an object. Methods in a class are functions or procedures that define the behavior or actions that objects of the class can perform. Methods operate on the data stored in the class properties. Classes may use access modifiers (e.g., public, private, protected) to control the visibility and accessibility of properties and methods. This helps enforce encapsulation and data protection. Objects are instances of a class created using the “new” keyword. When an object is created, it inherits the properties and methods defined in the class blueprint.

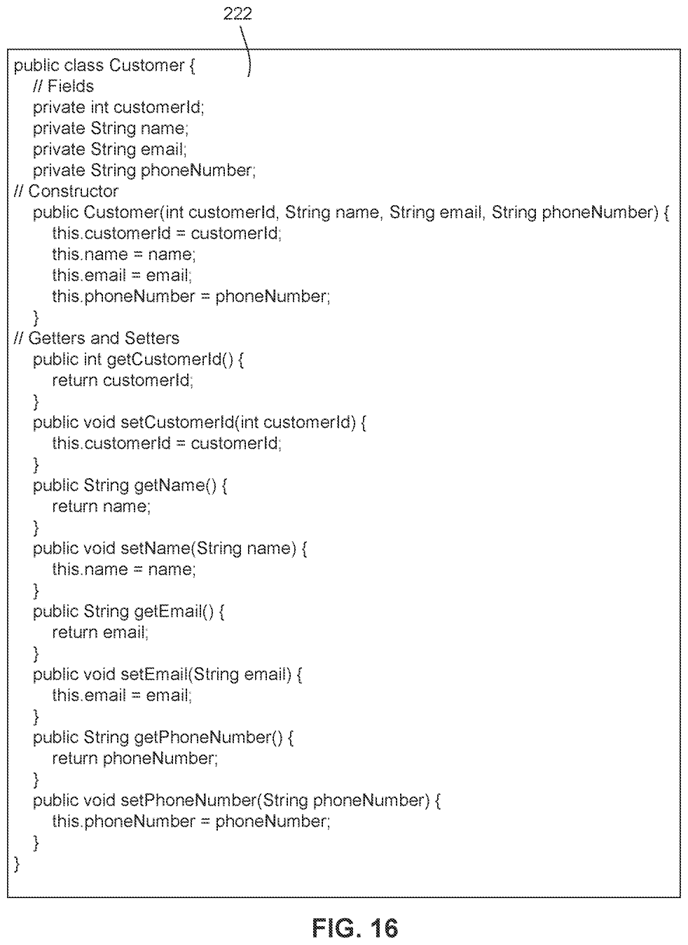

Once a user has defined the classes for a project, they are saved as class models 156 in the data store 180. FIG. 16 shown an exemplary class model 222.

### End-User Types

Referring back to FIG. 2A, the data development service 116 may allow a user to define end-user types for a project. End-user types define the roles and permissions within an application, which often involve various types of users, each with specific roles, needs, and expectations. Common end-user types include: standard users with basic access and functionalities, users with administrative privileges, and users with development privileges. Once a user has defined the user types for a project, they are saved as user models 159 in the data store 180.

### Structures

The data development service 116 may allow a user to define data structures for a project. Structures serve as a way to define a structure for holding data. Structures are similar to models except that they are not stored in a database. Structures are used for temporary data holding and passing data between different parts of an application. Structures may be employed in an application to (1) send data from a server to a client, providing a way to organize and convey information, (2) when one widget needs to send data to another widget, structures can serve as a structured format for passing information between these widgets, and (3) in classes or methods where temporary data needs to be held or manipulated, structs provide a convenient and lightweight way to structure the data without the need for persistent storage.

The data development service 116 may allow a user to define a unique name for each structure. The user may further define properties, property names, and property types for each structure. The name of the property serves as its identity within the structure and it uniquely identifies the specific data field. The type of a property specifies the kind of data it can hold, such as a primitive data type, another model, or an option set. The type defines the nature of the data the property can store, ensuring consistency and enabling the server 110 to generate appropriate backend structures. A user can define a property to hold a single value or multiple values, essentially turning it into a list or an array.

Once a user has defined the structures for a project, they are saved as structure models 157 in the data store 180. FIG. 15 shows an exemplary structure model 224.

### Scheduled Actions

Referring back to FIG. 2A, the data development service 116 may allow a user to define data scheduled actions for a project. Scheduled actions allow users to automate tasks or events based on specified schedules. These actions can be triggered at predefined times or intervals, enhancing the flexibility and efficiency of data-driven processes. The service 116 may allow a user to define a unique name for each scheduled action and a type. The type determines when the scheduled action should run. Actions may be scheduled to run at regular intervals, with a delay, based on a CRON expression (e.g., for a CRON job), or based on user defined conditions.

Once a user has defined the scheduled actions for a project, they are saved as action models 158 in the data store 180.

### Object Lists

The data development service 116 may allow a user to define object lists for use in managing objects from a specific model. Object lists simplifies the process of retrieving data by allowing users to configure various aspects of objects without writing code. That is, instead of writing code, users interact with a list of predefined objects or options, choosing the desired behavior or configuration without manually specifying each step in the code. The service 116 may allow a user to define a unique name for an object list and associate a model with that list.

Once a user has defined the object lists for a project, they are saved as object lists 163 in the data store 180.

### UI Development Service

In an embodiment, the server 110 may provide a UI development service 118 over the network 250 to the user device 200. For example, the user device 200 may access the UI development service 118 through a developer interface displayed in the web browser 202. The UI development service 118 allows a user at the device 200 to define the look, structure, characteristics and relationships of a UI for a software application. The service 118 may allow users to use widgets, pages and canvases to design a UI for a project. Each of these is discussed below.

### Widgets

Widgets are the fundamental unit of the UI that represents a specific visual or functional element within an application. Widgets serve as building blocks for constructing the overall UI, and they can range from simple elements like buttons and text fields to more complex components such as charts, tables, and interactive controls. That is, a widget is a graphical user interface component that end users can interact with and contribute to the visual representation and functionality of the application. One of the primary advantages of widgets is their reusability. Once created, a widget can be reused across different pages or with other widgets of the project. This promotes modular design and reduces redundancy in development. Widgets can have both visual representation and interactive behavior. For example, a button widget not only displays a clickable button but also triggers an action when clicked.

Widgets often have the ability to bind to data sources, allowing dynamic content updates based on changes in underlying data. This feature enables real-time updates and reflects the current state of the application. Widgets can emit events in response to user interactions or changes in their internal state. Users can define event handlers to respond to these events and implement custom logic. Users can configure the properties and appearance of widgets through the web interface. This includes setting styles, colors, and other visual aspects to align with the application's design. Widgets can be composed together to create more complex UI elements. They can interact with each other through events and data sharing, allowing the creation of sophisticated user interfaces. Widgets can be configured to dynamically update their content or appearance based on user actions, data changes, or other triggers. This dynamic behavior contributes to a responsive and engaging user experience. Widgets may be associated with the data models 150, allowing them to display, edit, or visualize data from the application's backend. This integration enhances the application's ability to manage and present information.

The UI development service 118 may allow a user to define a property for each widget. A property refers to a variable designed to store data within a widget. These properties can either be internally assigned, capturing data generated within the widget, or externally provided, serving as a container for values supplied from external sources. Properties play a crucial role in shaping the behavior and functionality of widgets within the application. A user can provide each property of a widget with a unique name. A user can also define a data type of the property. Data types may include a primitive data type, data model, option set, structure, or class. A user can also select whether the property is internal to a widget, meaning that a widget refers to a property that is utilized within the component itself and is not directly exposed for external manipulation. This type of property is often used for internal data management or to store values that are essential for the widget's functionality but do not need to be accessed or modified from outside the widget.

A user can also select whether a property of a widget is required. A “required” property in widget specifies whether a particular property must have a value assigned. If a property is marked as required, it means that when creating or updating an object based on this widget, a value for this property must be provided, and leaving it empty would result in a failure, ensuring essential data is captured. A user can also select whether a property of a widget holds a single value or a collection of values. A user can also select a default value for a property.

A user can also enable a fetch data option that allows users to generate queries and access properties from reference models. This functionality is valuable for retrieving and utilizing data from external sources within the widgets. When fetch data is enabled, it signifies that the widget should retrieve and make available the data associated with the referenced models.

Once a user has defined the widgets for a project, they are saved as widget models 160 in the data store 180.

### Pages

The UI development service 118 may provide a cloud-based interface on the device 200 that allows a user to create one or more pages for a project. A “page” represents a unit of the UI that typically corresponds to a specific view or screen in an application. Pages are fundamental building blocks in creating the structure and layout of the UI for an application. A page is composed of various widgets that define its visual and interactive elements. Widgets like logos, image blocks, forms, and other UI elements are assembled within a page to create a cohesive end-user experience. Unlike widgets, pages are often considered non-reusable. This is because the logic and structure of a page are typically specific to a particular view or screen in the application. While pages are often non-reusable, they can integrate and reuse widgets. This allows users to maintain a balance between creating specific views for pages and leveraging modular, reusable components for common UI elements.

Pages may be associated with routing logic that determines when and how they are displayed to the user. Routing involves mapping URLs or user actions to specific pages within the application. Pages define the arrangement and layout of various UI elements. These elements can include navigation bars, sidebars, content sections, and any other widgets needed to present information or gather input from the user. Pages can dynamically load and display content based on user interactions or data retrieved from the backend. This dynamic behavior enhances the responsiveness and flexibility of the application. Overall, pages play a crucial role in defining the structure and flow of the application's user interface. They serve as containers for assembling components and organizing the visual elements that make up different views within the application.

Once a user has defined the pages for a project, they are saved as page models 162 in the data store 180.

### Canvas

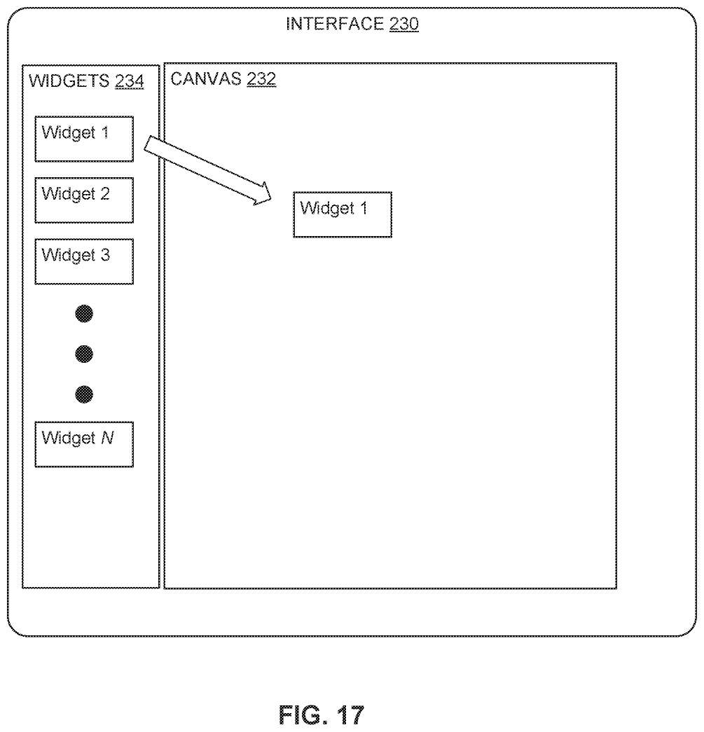

The UI development service 118 may provide a cloud-based interface on the device 200 that provides a virtual canvas where users can arrange, design, and organize various UI elements, including widgets, to create a cohesive and visually appealing end-user experience for a project. Referring to FIG. 17, an exemplary interface 230 depicts a canvas 232 where users can drag and drop widgets 234.

### Core Models

Referring to FIG. 2B, the core models 182 of a project are shown. These core models 182 include the data models 150, query models 152, option models 154, class models 156, structure models 157, action models 158, user models 159, widget models 160, and page models 162. The core models 182 of a project serve as the foundational elements for building a design codebase that can be used to generate source code for one or more applications. It will be appreciated that utilizing these core models 182 foster a standardized and efficient approach to application development.

### Design Codebase Generating Service

Referring back to FIG. 2A, the server 110 may provide a design codebase generating service 122. The service 122 may generate a design codebase for a project based on one or more of the core models 182 (see FIG. 2B). The service 122 may generate and update the design codebase automatically, such as after each time a user provides input through developer interfaces for the services 114-118. Alternatively, the service 122 may generate code responsive to a user request.

The design codebase generated by the code base generation service 122 may be in a base programming language that is designed to be easy to learn and use, while still being powerful enough to handle complex business logic. In an embodiment, the base programming language supports variable declaration, expressions, statements (if, loops, switch, etc.). The base programming language supports exception handling. The base programming language further supports classes, enums, constructors, methods and fields. The base programming language further supports factory constructs. The base programming language further supports named parameters, optional parameters, and positional parameters. The base programming language further supports dynamic types and dynamic methods. The base programming language used by the design codebase is unique in that it defines the front end, back end, and database components and database structure of a computer application. The design codebase may be code automatically generated for the user interface (front end), (business logic) back-end, and database components for all parts of the computer application.

The design codebase generated by the service 122 may be saved in the data store 180 as design codebase 164. It will be appreciated that the design codebase 164 may not be source code for an application-meaning that it cannot be compiled, interpreted or executed. Instead, the design codebase 164 may be a code that is used to generate sets of source code, e.g., front-end code and back-end code, for an application as will be explained below. The design codebase 164 may be in a base programming language that is abstracted and able to be converted into any type of source code for known programming languages. The design codebase 164 may be an intermediate code created before generating source code.

The code base generation service 122 may also track, build and manage the dependencies that are used in the application that is being developed. In the past users had to make sure the correct libraries were incorporated into their code to make sure the code worked. In the code base generation service 122, when a new model, structure, query, component, electronic page, application node, or digital object is created, then the library dependencies for the new object to be used and executed are also known by the code base generation service 122 and tracked. Thus, the other code components in the programming language and/or then in the final target language may be tracked in dependency tables or extracted from information associated with each new object as the objects are exported or compiled from the UI development service 118 to the programming language and then to the final target language (e.g., Java). If digital objects are imported to the application, these dependencies can be defined by a user who is importing the objects for use in the application.

### Code Editing Service

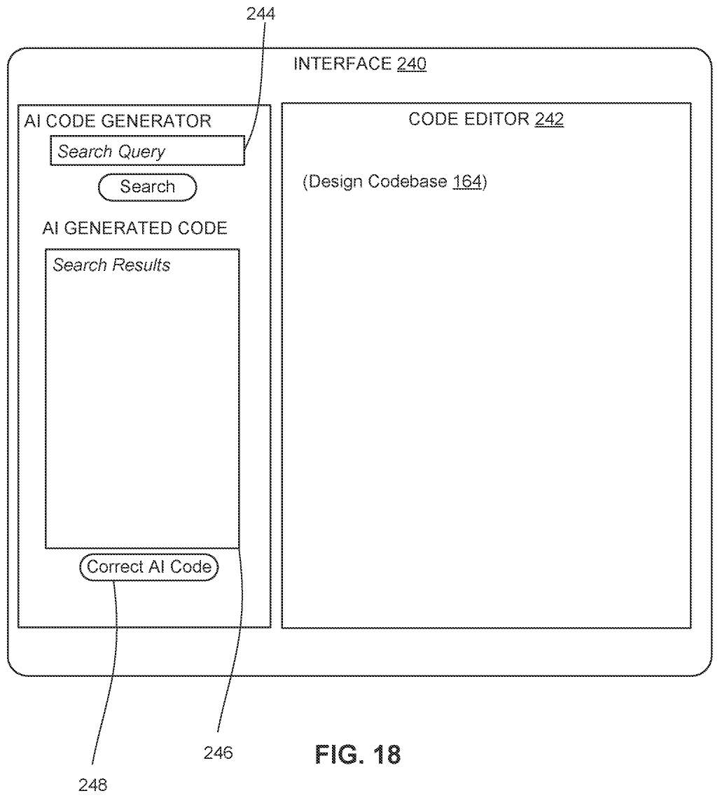

In an embodiment, the server 110 may provide a cloud-based code editing service 123 over the network 250 to the user device 200. For example, the user device 200 may access the code editing service 123 through a developer interface displayed in the web browser 202. The code editing service 123 may allow a user at the device 200 to directly write, edit, and manage the design codebase 164. Referring to FIG. 18, there is shown an interface 240 that may be displayed on the user device 200. The interface 240 may provide a code editor 242 that allows a user to directly edit portions of the design codebase 164. In addition, the code editor 242 may allow a user to directly edit the design codebase for the core models 182.

### AI Code Generating Service

Referring back to FIG. 2A, the server 110 may provide a cloud-based artificial intelligence (AI) code generation service 124 over the network 250 to the user device 200. For example, the user device 200 may access the AI code generation service 124 through a developer interface displayed in the web browser 202. The AI code generation service 124 may allow a user at the device 200 to provide user input to request that the AI code generation service 124 generate code using AI. The request may be made by a user in plain or natural language. In response to the request, the AI code generation service 124 may generate code based upon the request. To generate the code using AI, the AI code generation service 124 may include an AI model 165 that uses machine learning to train itself from AI datasets 166 of existing source code. The generated code may be stored in as AI generated code 167 in the data store 180.

It will be appreciated that the AI generated code 167 generated by the service 124 may be generic or boilerplate code-meaning that it is incompatible with the design codebase 164. This incompatibility may include a programming or framework mismatch, different coding styles, dependency conflicts, architecture misalignment, syntax and other errors. In other words, the AI generated code 167 cannot simply be copy and pasted into the design codebase 164 due to one or more incompatibilities.

Referring to FIG. 18, the interface 240 may provide a text input box 244 that allows a user to provide input that causes the AI code generation service 124 to generate code in response to the user selecting the “Search” button. The AI generated code may be displayed in the text box 246.

### Code Correction Service

Referring back to FIG. 2A, the server 110 may provide a code correction service 126. The code correction service 126 may correct the AI code 167 generated by the AI code generation service 124 such that it is compatible with the design codebase 164. That is, the code correction service 126 may modify and optimize the AI code 167 such that it is compatible with the data constraints of the design codebase 164. The code generated by the service 126 may be stored as corrected code 168 in the data store 180. The code correction service may further use machine learning, heuristic rules, case rules, syntax rules, semantic rules, and other types of correction tactics to correct the AI code 167 that was generated. For example, the code correction service 126 may also correct syntax errors, semantic errors, data model inconsistencies or hallucinations that may occur in the AI generated code.

The code correction service 126 not only validates but can also optimize the AI code 137 by rigorously enforcing adherence to base programming language specifications and syntax, thereby ensuring the production of high-caliber software. In addition, this approach may significantly streamline the software development lifecycle, boosting efficiency and ensuring uniformity across all aspects of application development, whether web-based or mobile. This approach not only elevates the quality and consistency of web and mobile applications but also significantly boosts development efficiency by automating and streamlining a significant portion of the coding process.

Referring to FIG. 18, the interface 240 may provide a virtual button 248 that allows a user to manually cause the code correction service 126 to act. Alternatively, the code correction service 126 may automatically correct the AI generated code 167. The corrected code 168 may be displayed in text box 246.

### Code Management Service

Referring back to FIG. 2A, the server 110 may provide a code management service 128. The code management service 128 may automatically insert or merge the corrected code 168 into the design codebase 164. The resulting code is resaved into the design codebase 164 in the data store 180. Alternatively, a user may copy and paste the corrected code 168 into the design codebase 164 and save the corrected cod 168.

### Application Management Service

The server 110 may provide a application management service 129 over the network 250 to the user device 200. For example, the user device 200 may access the application management service 129 through a developer interface displayed in the web browser 202. The application management service 129 allows a user at the device 200 to identify one or more sets of target source code for a project through the cloud-based interface.

Broadly speaking, an application is a UI client that can access data in a database. Applications are the main entry point for end users. End users likely engage with different applications based on their specific functionalities or purposes. Using the application management service 129, a user can create one or more sets of source code from a project, each set corresponding to a different application for the same project. For example, each project can be used to build and deploy different applications, e.g., a Flutter application or a React application. In broad terms, a project comprises the core models 182 in FIG. 2B. It will be appreciated that the use of the application-independent design codebase 164 allows multiple sets of source code to be created from a single project.

The application management service 129 may allow a user to name each set of source code for a project with a unique name. The application management service 129 may further allow a user to designate a root page from the page models 162. The root page is the initial entry point and the first page displayed when an application is launched and sets the foundation for the end-user's interaction with the application, and the behavior of the application starts from this point. Internal pages, representing different functionalities or sections, are navigated from the root page. Users have the ability to select a different page from a root page list for each application.

The application management service 129 may provide a cloud-based interface where users can choose their preferences for each application. This feature allows users to customize their development environment based on their preferred (1) programming languages/frameworks for the front end and the back end of an application, (2) a relational database management system, and (3) a cloud platform. For example, front-end programming languages/frameworks may include, but is not limited to, HTML, CSS, Javascript, Dart, Flutter, or React JS. Back end programming languages/frameworks may include, but is not limited to, JavaScript (Node.js), Python (Django, Flask), Ruby (Ruby on Rails), Java (Spring Boot), PHP (Laravel), Express.js (JS), PHP and C#(ASP.NET) for the back end. Relational database management systems may include, but is not limited to, PostgreSQL, MySQL, Microsoft SQL Server, and Oracle Database. Cloud platforms may include Google Cloud Platform, Microsoft Azure, and Amazon Web Services.

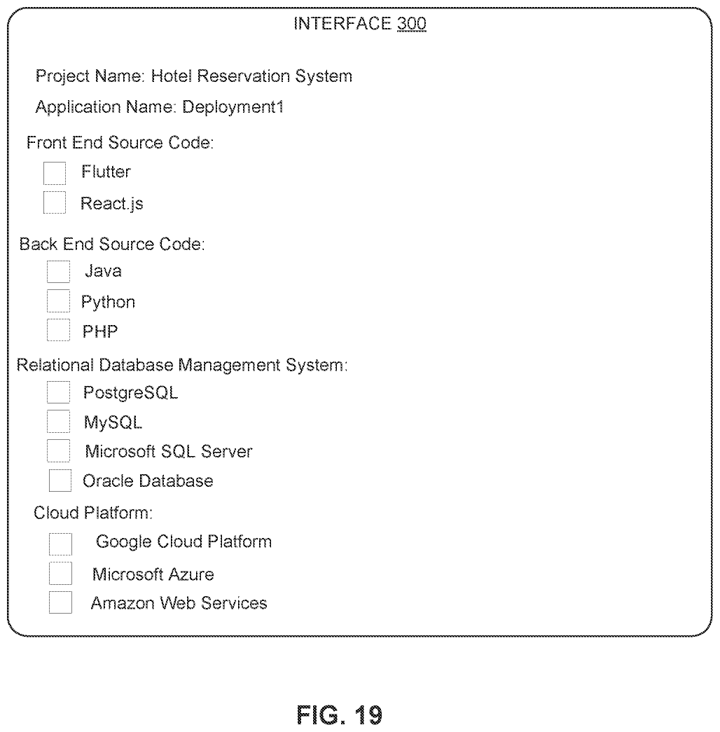

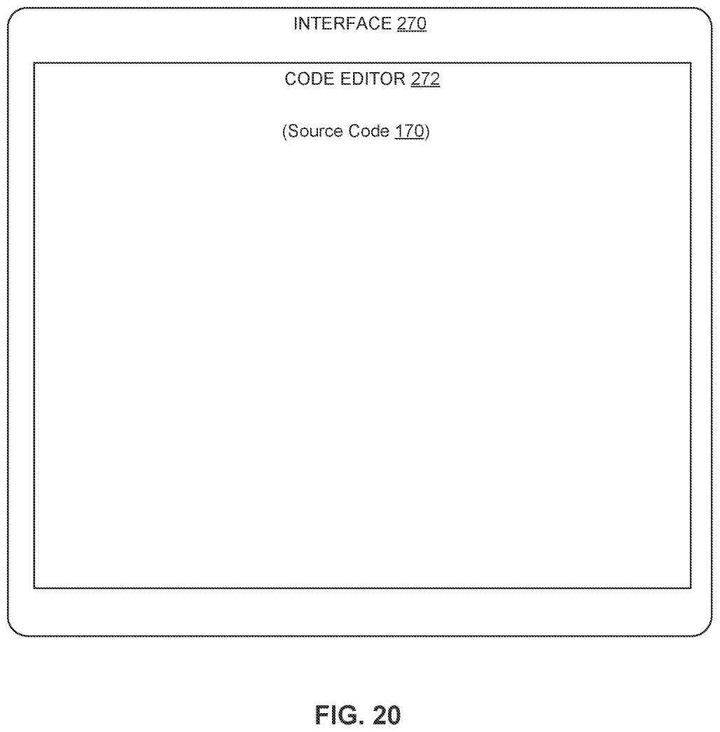

FIG. 19 depicts an exemplary interface 300 that allows a user to select preferred programming languages/frameworks for the front end and the back end, a relational database management system, and a cloud platform for an application generated from a project. Again, a user may generate multiple sets of source code in different programming languages from a single project design codebase. In this regard, a design codebase may serve as the base for creating source code for multiple applications.

### Source Code Generation Service

Referring back to FIG. 2A, the server 110 may provide a source code generation service 130. The source code generation service 130 generates source code for an application based on the user preferences made through the application management service 129 and the design codebase 164. The source code may be spread across multiple files of different formats. The source code generation service 130 may include a front-end service 132 and a back-end service 134. The front-end service 132 may generate the source code for the front-end for the application. The back-end service 134 may generate the source code for the back-end of the application. The source code generated by the source code generation service 130 may be saved as source code 170, including server-side code 172 and client-side code 174, in the data store 180.

Referring to FIG. 2C, as can be observed, the core models 182 are utilized to generate the design codebase 164 for a project. From the design codebase 164, the source code 170, including client-side code 172 and server-side code 174, for multiple applications 1-N can be generated based on user preferences. This is beneficial because each of the applications 1-N can be deployed to different computing platforms, including web platforms and mobile platforms.

Referring to FIG. 20, the server 110 may provide an interface 270 on the user device 200 that includes a code editor 272 that allows a user to directly view and edit the source code 170 for an application. Further, as discussed above, the service 130 may provide multiple versions of source code in different programming languages based on the same design codebase 164. That is, each the multiple applications generated from the same design codebase 164 may have different source code depending on user preferences. This also means that the same application can be generated for different platforms using the same code based. For example, the same application can be for mobile, desktop, web applications, iOS, Windows, Linux, etc. from the same code base.

### Application Deployment Service

Referring back to FIG. 2A, the server 110 may provide an application deployment service 136. Once the source code 170 has been generated by the source code generation service 130, the application deployment service 136 may generate a deployment package in response to a user request. The deployment package may include source code, including client-side code and server-side code. The deployment package may further include a database schema that defines a structure of a database for the application, including tables, columns, relationships, indexes, and constraints. The deployment package may also include dependencies, including any required third-party libraries, modules, or packages. The deployment package may also include any static assets, including images, fonts, stylesheets, and scripts, necessary for the front-end presentation of the website. The deployment package may include frameworks and libraries, such as Django, Ruby on Rails, Flask, Express.js, jQuery, and React.js. The deployment package may also include deployment scripts, including scripts to automate the deployment process, including tasks such as copying files to the server, setting up the environment, configuring the database, etc. The deployment package may further include a variety of application programming interfaces (APIs), including database APIs.

The application deployment service 136 may deploy the deployment package to a cloud platform 252, such as a web or application server. In addition, the application deployment service 136 may configure a database 254 on a database platform for storing the application data. For example, the application deployment service 136 may deploy the deployment package to Google Cloud Platform (GCP), Microsoft Azure, or Amazon Web Services (AWS). If necessary, the service 136 may compile and package the source code 170 prior to deployment to the cloud platform 252.

End-users may access the application on the cloud platform 252 from an end-user computing device (not shown). For example, if the application is a web-based application, it can be accessed by an end-user through a web browser on a user computing device. Suitable end-user computing devices include desktop computers, laptops or notebook computers, tablet computers, mobile devices, mainframe computer systems, handheld computers, workstations, network computers, or other devices with like capability.

### Exemplary Methods

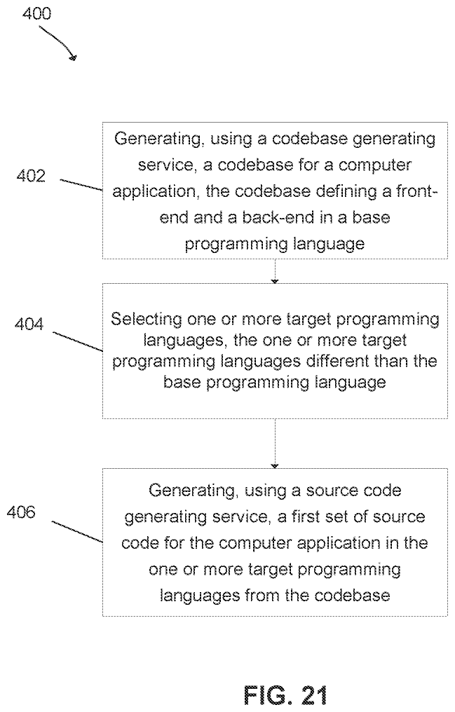

FIG. 21 illustrates a flowchart 400 for an example of a method for enabling development of a computer application. At step 402, the method generates, using a design codebase generating service, a design codebase for a computer application, the design codebase defining a front-end and a back-end in a base programming language. At step 404, the method selects one or more target programming languages, the one or more target programming languages different than the base programming language. At step 406, the method generates, using a source code generating service, a first set of source code for the computer application in the one or more target programming languages from the design codebase.

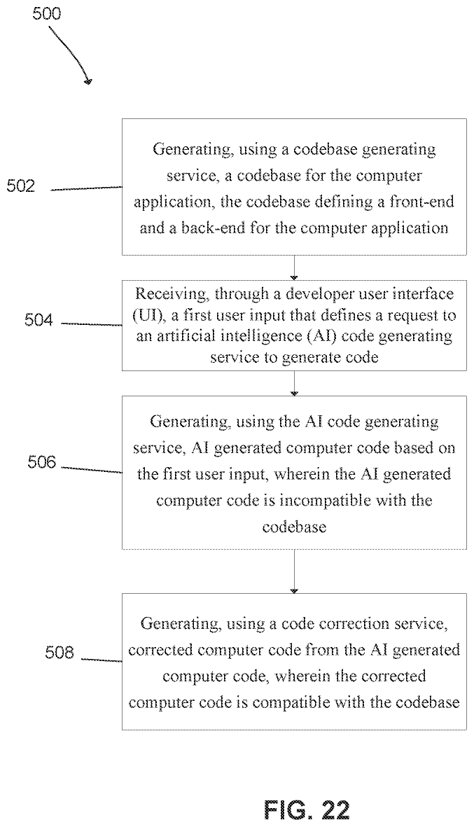

FIG. 22 illustrates a flowchart 500 for an example of a method for enabling development of a computer application. At step 502, the method generates, using a design codebase generating service, a design codebase for the computer application, the design codebase defining a front-end and a back-end for the computer application. At step 504, the method receives, through a developer user interface (UI), a first user input that defines a request to an artificial intelligence (AI) code generating service to generate code. At step 506, the method generates, using the AI code generating service, AI generated computer code based on the first user input, wherein the AI generated computer code is incompatible with the design codebase. At step 508, the method generates, using a code correction service, corrected computer code from the AI generated computer code, wherein the corrected computer code is compatible with the design codebase.

### Exemplary Readable Storage Medium

In an embodiment, the present disclosure includes a non-transitory machine readable storage medium having instructions embodied thereon, the instructions, when executed by one or more processors, cause the one or more processors to perform a process comprising: generating a design codebase for the computer application, the design codebase defining a front-end and a back-end in a base programming language; receiving a first user input that selects one or more target programming languages, the one or more target programming languages different than the base programming language; and generating a first set of source code for the computer application in the one or more target programming languages from the design codebase.

### Exemplary Device

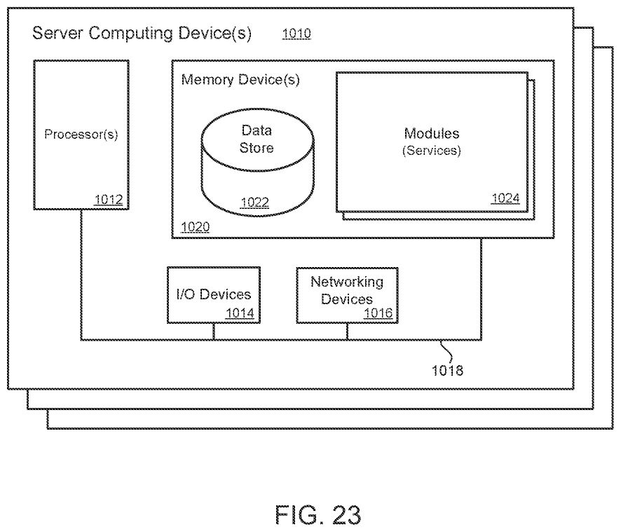

FIG. 23 illustrates a server computing device 1010 on which modules, also referred to herein as services, of this technology may execute. The computing device 1010 is illustrated on which a high-level example of the technology may be executed. The computing device 1010 may include one or more processors 1012 that are in communication with memory devices 1020. The computing device may include a local communication interface 1018 for the components in the computing device. For example, the local communication interface may be a local data bus and/or any related address or control busses as may be desired.

The memory device 1020 may contain modules 1024 that are executable by the processor(s) 1012 and data for the modules 1024. The modules 1024 may execute the functions described earlier. A data store 1022 may also be located in the memory device 1020 for storing data related to the modules 1024 and other applications along with an operating system that is executable by the processor(s) 1012.

Other applications may also be stored in the memory device 1020 and may be executable by the processor(s) 1012. Components or modules discussed in this description that may be implemented in the form of software using high programming level languages that are compiled, interpreted or executed using a hybrid of the methods.

The computing device may also have access to I/O (input/output) devices 1014 that are usable by the computing devices. An example of an I/O device is a display screen that is available to display output from the computing devices. Other known I/O device may be used with the computing device as desired. Networking devices 1016 and similar communication devices may be included in the computing device. The networking devices 1016 may be wired or wireless networking devices that connect to the internet, a LAN, WAN, or other computing network.

The components or modules that are shown as being stored in the memory device 1020 may be executed by the processor 1012. The term “executable” may mean a program file that is in a form that may be executed by a processor 1012. For example, a program in a higher level language may be compiled into machine code in a format that may be loaded into a random access portion of the memory device 1020 and executed by the processor 1012, or source code may be loaded by another executable program and interpreted to generate instructions in a random access portion of the memory to be executed by a processor. The executable program may be stored in any portion or component of the memory device 1020. For example, the memory device 1020 may be random access memory (RAM), read only memory (ROM), flash memory, a solid state drive, memory card, a hard drive, optical disk, floppy disk, magnetic tape, or any other memory components.

The processor 1012 may represent multiple processors and the memory 1020 may represent multiple memory units that operate in parallel to the processing circuits. This may provide parallel processing channels for the processes and data in the system. The local interface 1018 may be used as a network to facilitate communication between any of the multiple processors and multiple memories. The local interface 1018 may use additional systems designed for coordinating communication such as load balancing, bulk data transfer, and similar systems.

While the flowcharts presented for this technology may imply a specific order of execution, the order of execution may differ from what is illustrated. For example, the order of two more blocks may be rearranged relative to the order shown. Further, two or more blocks shown in succession may be executed in parallel or with partial parallelization. In some configurations, one or more blocks shown in the flow chart may be omitted or skipped. Any number of counters, state variables, warning semaphores, or messages might be added to the logical flow for purposes of enhanced utility, accounting, performance, measurement, troubleshooting or for similar reasons.

Some of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more blocks of computer instructions, which may be organized as an object, procedure, or function. Nevertheless, the executables of an identified module need not be physically located together, but may comprise disparate instructions stored in different locations which comprise the module and achieve the stated purpose for the module when joined logically together.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices. The modules may be passive or active, including agents operable to perform desired functions.

The technology described here can also be stored on a computer readable storage medium that includes volatile and non-volatile, removable and non-removable media implemented with any technology for the storage of information such as computer readable instructions, data structures, program modules, or other data. Computer readable storage media include, but is not limited to, RAM, ROM, EEPROM, flash memory or other memory technology, CD-ROM, digital versatile disks (DVD) or other optical storage, magnetic cassettes, magnetic tapes, magnetic disk storage or other magnetic storage devices, or any other computer storage medium which can be used to store the desired information and described technology.

The devices described herein may also contain communication connections or networking apparatus and networking connections that allow the devices to communicate with other devices. Communication connections are an example of communication media. Communication media typically embodies computer readable instructions, data structures, program modules and other data in a modulated data signal such as a carrier wave or other transport mechanism and includes any information delivery media. A “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared, and other wireless media. The term computer readable media as used herein includes communication media.

Reference was made to the examples illustrated in the drawings, and specific language was used herein to describe the same. It will nevertheless be understood that no limitation of the scope of the technology is thereby intended. Alterations and further modifications of the features illustrated herein, and additional applications of the examples as illustrated herein, which would occur to one skilled in the relevant art and having possession of this disclosure, are to be considered within the scope of the description.

Furthermore, the described features, structures, or characteristics may be combined in any suitable manner in one or more examples. In the preceding description, numerous specific details were provided, such as examples of various configurations to provide a thorough understanding of examples of the described technology. One skilled in the relevant art will recognize, however, that the technology can be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements can be devised without departing from the spirit and scope of the described technology.

What is claimed is:

1. A method of enabling development of a computer application, comprising:
generating, using a design codebase generating service, a design codebase for the computer application, the design codebase defining a front-end and a back-end in a base programming language for the computer application;
selecting, using a source code generation service, one or more target programming languages, the one or more target programming languages being different than the base programming language; and
generating, using the source code generating service, a first set of source code for the computer application in the one or more target programming languages from the design codebase.

2. The method of claim 1, wherein the first set of source code comprises client-side source code and server-side source code.

3. The method of claim 1, wherein generating the design codebase further comprises generating the design codebase based on one or more core models, wherein the core models comprise data models, query models, class models, structure models and page models.

4. The method of 1, further comprising: generating, using the source code generating service, a second set of source code for a second computer application from the design codebase.

5. The method of claim 1, further comprising deploying, using an application deployment service, the computer application to a cloud computing platform.

6. The method of claim 5, further comprising configuring a database for use by the computer application.

7. The method of claim 1, wherein the computer application is a web application or a mobile application.

8. A method of enabling development of a computer application comprising:
generating, using a design codebase generating service, a design codebase for the computer application, the design codebase defining a front-end and a back-end for the computer application;
receiving, through a developer user interface (UI), a first user input that defines a request to an artificial intelligence (AI) code generating service to generate code;
generating, using the AI code generating service, AI generated computer code based on the first user input, wherein the AI generated computer code is incompatible with the design codebase; and
generating, using a code correction service, corrected computer code from the AI generated computer code, wherein the corrected computer code is compatible with the design codebase.

9. The method of claim 8, wherein the design codebase and the AI generated computer code are incompatible because they are in different programming languages.

10. The method of claim 8, wherein the design codebase and the AI generated computer code are incompatible because the AI generated code has syntax errors.

11. The method of claim 8, further comprising incorporating, using a code management service, the corrected computer code into the design codebase.

12. The method of claim 11, further comprising generating, using a source code generating service, a first set of source code for the computer application in one or more target programming languages from the design codebase after the corrected computer code is incorporated into the design codebase.

13. The method of claim 12, wherein the first set of source code comprises client-side source code and server-side source code.

14. The method of claim 13, further comprising deploying, using an application deployment service, the computer application to a cloud computing platform.

15. The method of claim 12, further comprising generating, using a source code generating service, a second set of source code for the computer application in one or more target programming languages from the design codebase after the corrected computer code is incorporated into the design codebase.

16. A non-transitory machine readable storage medium having instructions embodied thereon, the instructions, when executed by one or more processors, cause the one or more processors to perform a process comprising:
generating a design codebase for the computer application, the design codebase defining a front-end and a back-end in a base programming language;
selecting one or more target programming languages, the one or more target programming languages different than the base programming language; and
generating a first set of source code for the computer application in the one or more target programming languages from the design codebase.

17. The non-transitory machine readable storage medium of 16, wherein the first set of source code comprises client-side source code and server-side source code.

18. The non-transitory machine readable storage medium of claim 16, wherein generating the design codebase further comprises generating the design codebase based on one or more core models, wherein the core models comprise data models, query models, class models, structure models and page models.

19. The non-transitory machine readable storage medium of claim 16, wherein the process further comprises generating a second set of source code for a second computer application from the design codebase.

20. The non-transitory machine readable storage medium of claim 16, wherein the process further comprises deploying the computer application to a cloud computing platform.
